(19) United States
(12) Patent Application Publication
(10) Pub. No.: US 2011/0097699 A1
(43) Pub. Date: Apr. 28, 2011

(54) Magnetically erasable writable educational flash card and method for making the same

(75) Inventor: Shengmin Wen, Apex, NC (US)

(73) Assignee: Shengmin Wen, Apex, NC (US)

(21) Appl. No.: 12/605,321

(22) Filed: Oct. 24, 2009

(51) Int. Cl. B43L 1/00

(52) U.S. Cl. 434/409

(57) ABSTRACT

Disclosed herein are a magnetically erasable writable educational flash card and method for making the same. The method uses a flash card comprising magnetic display panel, a magnetic die of predetermined pattern such as text character of a language, Arabic numeral, symbol or graphical picture of a learning subject, and a magnetic eraser. To make an educational flash card, a controlled repeated small amplitude sliding movement is applied to the flash card's magnetic display panel in contact with the face of the magnetic die resulting visual display of a mirrored silhouette of the magnetic die's predetermined pattern being created on the magnetic display panel. Two or more such cards comprise an educational flash card set for young children. The advantages of such flash card set include: more effective and enjoyable learning through participation, ergonomically fitful for fine motor skills development, better structured and creative learning, and changeable displaying indicia.

### BACKGROUND OF THE INVENTION

1. Field of the Invention

The present invention generally relates to the field of educational flash card, and more particularly to a magnetically erasable writable flash card intended for use in teaching young children elements of a learning subject.

2. Description of the Prior Art

Conventional paper flash cards have been used as teaching tools for centuries not only for their effectiveness but also for their commercial success. They are still produced and sold in various forms at a very reasonable and affordable price to virtually every household and pre-school. For example, School Zone Publish Company, Grand Haven, Mich., USA, publishes and sells the Alphabet Flash Cards, product #04001 with ISBN 9780938256861 and the Numbers 1-100 Flash Cards, product #04005 with ISBN 9780938256908. Both products are cited as references here and referred to as “conventional paper flash card.” The conventional paper flash cards are permanently printed with unique indicia on each individual card and a complete set of flash cards comprises a plurality of such permanently printed unique cards. There are several disadvantages when they are used for teaching young children. Take the widely used Alphabet Flash Cards as an example, the common noticed disadvantages are: (1) to teach any alphabet, a whole set of cards is needed all the time. If one card is missing, for example it may have got lost or damaged, which happens quite often when young children play with the cards, user needs to buy another whole set to get just the missing card(s); (2) the conventional paper flash card is made of conventional paper and its mass or weight is seldom ergonomically optimized for young children. Conventional letter paper flash cards appear less like a toy in comparison to wooden letter blocks, which is more favored by young children. For example, the Magnetic Wooden Alphabet toy, item number 448, produced by Melissa & Doug LLC, Westport, Conn., USA, has the size and weight ergonomically fit for young children. This product is cited here as a reference; (3) young children typically have an extremely limited attention span (e.g., less than five minutes for pre-school children). Consequently, young children may become easily bored and distracted when they use conventional paper flash cards because the indicia of conventional paper flash card is permanently printed and provided therefore the conventional paper flash cards lack ways to effectively engage and entertain young children with fun of participation like a creative toy does; (4) to spell a word or a sentence with repeated letters, a number of flash card sets are needed. For example, to spell the word “vegetable,” three sets of conventional English alphabet paper flash cards are needed to just get the additional two e-cards. To spell out a sentence “mommy loves jimmy,” five lower case m-cards are needed and therefore user needs to use five sets of paper flash cards in order to get all the five m-cards. Five sets would total 130 cards for English alphabets. Such solution is not desirable because not only five sets cost five times more but also precious play time is wasted on finding out just the right letters through a pile of 130 cards; (5) one set of alphabet flash cards is not sufficient to play some fun word learning games, such as the fun scrambling and unscrambling word game wherein a word often has the same letter more than once and more than one word is needed to lay down at the same time. This could be one of the reasons why the conventional English alphabet paper flash cards are not part of children's language learning process any more after their preschool age when they grow out of learning only the alphabet.

U.S. Pat. No. 5,199,714 issued on Apr. 6, 1996 to D. D. Harper entitled “Method of playing a word solitaire card game” disclosed a card set comprising 52 cards including 50 letter cards and 2 blank cards as wild cards. The 50 letter cards are distributed among 26 alphabet letters according to certain frequency, with frequently used letters in English words have more cards than less frequently used letters. For example letter “E” has four cards, letter “O” has three cards and letter “Z” has only one card. The blank cards can be used as any letter. This deck of cards can form most of words without difficulty, such as the word “vegetable.” It still cannot form a simple sentence like “mommy loves jimmy” because even with the two blank cards are used as m-cards there is still a shortage of one m-card.

U.S. Pat. No. 6,276,940 issued on Aug. 21, 2001 to C. L. White entitled “Card game for learning the alphabet” disclosed a card set comprising 118 cards. These cards are distributed among 26 alphabet letters according frequencies the alphabet letter appears in English words. If used as flash cards, the card set can spell almost any sentence that young children can understand. However, to find one particular card through a pile of 118 cards can cause frustration and take time which otherwise could be spent on card playing activities.

U.S. Pat. No. 4,690,410 issued Sep. 1, 1987 to A. S. Berton entitled “Word forming tile game” disclosed a word forming game that uses a set of tiles with each tile bears one letter. The patent does not specify the total number of tiles or the size and weight of the tile. If used as flash cards, the tiles should be made with certain size and weight. Assume size and weight of the tile is ergonomically fit for young children, a total of 50 tiles are likely needed with 26 tiles for each letter and the rest distributed among letters according their appearance frequencies in English words. These many tiles with a size of standard flash card would not be preferred.

Magnetic display panel was invented many decades ago. For example, U.S. Pat. No. 3,036,388 issued on May 29, 1962, to C. R. Tate disclosed a “Magnetic Writing Materials Set.” This patent is cited here as a reference. The magnetic writing materials comprise a sheet of a front surface and a rear surface with magnetized balls and fluid sealed in between these two surfaces. The two poles of the magnetized balls are painted with contrasting colors. When a magnetic writing tip rubs on the front surface of the sheet, the tip's magnetic field causes re-orientation of the magnetized balls under the path of the tip therefore visually displaying the path on the front surface. A magnetic eraser can be used to re-orient uniformly all the magnetized balls therefore to erase display of the path of the tip. A different type of magnetic display panel was disclosed in U.S. Pat. No. 4,536,428 issued on Aug. 20, 1985, to Y. Murata, entitled “Magnetic Display Panel.” This patent is cited here as reference as well. The magnetic display panel is a multiple-cell structure comprises independent cells that hold fine magnetic particles in a special liquid. These cells are sandwiched between two substrates. Visual display is recorded on the panel by a movable marking device having an oriented magnetic field. There are many more variations of magnetic display panel, for example, U.S. Pat. No. 5,018,979 issued on May 28, 1991, to M. Gilano, entitled “Magnetic Visual Display,” U.S. Pat. No. 5,846,630 issued on Dec. 8, 1998 to H. Horoshi, entitled “Magnetic migration display panel,” and U.S. Pat. No. 6,299,972 issued on Oct. 9, 2001 to T. Iwasaki, entitled “Microcapsule Magnetic Display Sheet and A Method Thereof.” These patents are all cited as references. In this specification, all types and variations of magnetic display materials will be referred as magnetic display panel.

There are many patents issued worldwide to inventions that make use of magnetic display panel. A representative patent can be found in U.S. Pat. No. 5,186,631 issued on Feb. 16, 1993 to H. Okutsu, entitled “Magnetic Display Device.” The patent is cited here as a reference. Currently, one of the most popular applications of magnetic display panel is the so called Magna Doodle type of magnetic drawing toys, wherein the magnetic display panel is used as a doodle pad together with a magnetic stylus as a drawing pen and a magnetic bar as an eraser, for example, the Doodle Sketch™ produced by The Ohio Art Company, Bryan, Ohio, USA, and the Kid-Tough™ Doodler produced by Fisher-Price Inc., East Aurora, N.Y., USA. The product descriptions from both companies are cited here as references. Often such toys come with several magnetic stampers of simple shape such as rectangle, triangle and circle or plastic stencils such as certain carton figures for additional fun of doodling. But, such toys are not designed for structured educational and learning purpose. There are, however, inventions and products attempting to make use of the magnetic display device for structured educational and learning activities in addition to just doodling. For example, U.S. Pat. No. 5,949,050 issued on Sep. 7, 1999, to M. E. G. Fosbenner with the title of “Magnetic cards having a layer being permanently magnetized in a fixed configuration” disclosed a magnetic card that is specially designed to use on a magnetic display panel. The magnetic card can leave on the magnetic display panel an image that has a silhouette identical in configuration to that of the permanently magnetized component(s) or portion(s) in the magnetic card sealed by opaque outer layers. This card has the advantage of bringing predetermined configurations of a learning subject into the magnetic display device thus adding structured learning to the fun of doodling. However this card has at least three disadvantages: its complex structure makes it more expensive to manufacture; its opaque outer layers increase the distance between the card's magnetized component and the magnetic display panel therefore greatly weakens the card's magnetic field strength to write on the magnetic display panel; and the limited thickness of the card is not optimum for young children to ergonomically operate the card on a planar magnetic display panel of a magnetic display device. The patent is cited here as a reference. Another example is a product manufactured by Fisher-Price Inc., East Aurora, N.Y., USA. It is the product # M4773, “Basic Doodle Pro w/Magnetic Letters” released in 2007. The product introduced a set of magnetic alphabet stampers for use with the magnetic display device. Children may have fun playing the stampers, but for educational purpose this product has the following disadvantages: size and shape of the alphabet stampers is not optimum for young children to operate; the contrast and resolution on the display panel has been poor in comparison to conventional paper flash card; the displaying area of the magnetic display panel is limited for accommodating the large sized alphabet letters; and the alphabet letters can easily be missing. This product was discontinued within one year in 2008. This product is also included here in the reference.

After intensive literature search including US patents, it is concluded that the state of art of educational flash cards or those closely related teaching apparatus that could be used as educational flash cards is that educational flash cards comprise individual card or tile that has indicia permanently printed on its surface. Because of such feature, the disadvantages (1) to (5) listed at the beginning of this section are inherent. On the other hand, the magnetic display panel has great advantage of providing changeable display but yet need to find effective ways to provide structured educational and learning activities.

In full consideration of the preceding review, it is desirable to take advantages of both the conventional paper flash card and the magnetic display panel to create a totally new type of educational flash card with magnetic display panel. This new type of flash card will have its form factor similar to that of the conventional paper flash card but not have its indicia permanently printed on its surface. Instead, user can change, write and erase the indicia or displaying content on the flash card with a magnetic writer and eraser. Therefore user is entirely engaged during the whole learning activity by creating flash card to display any predetermined pattern as what appears in a conventional paper flash card. In addition, it is desirable that the card has certain mass, size and attractive look and is ergonomically fit for young children to play as a toy. The advantages of such card shall become apparent upon reading the subsequent portions of this specification.

### BRIEF SUMMARY OF THE INVENTION

One object of the present invention is to provide a magnetically erasable writable educational flash card and method for creating the flash card. The card comprises magnetic display panel. A visual display of a predetermined pattern on the magnetic display panel of the flash card can be erased and written by user through a magnetic eraser and a magnetic writer respectively. The magnetic writer provides a plurality of magnetic die assemblies with each magnetic die assembly having at least one magnetic die that is of a predetermined pattern of an element of a learning subject. An adequate number of such magnetic die assemblies are included in the magnetic writer to provide a complete set of elements of the learning subject. User can choose a particular element die from these magnetic die assemblies and use it to magnetically create or write visual display of the element of the learning subject on the magnetic display panel of a flash card to create a magnetically erasable writable educational flash card. As such, a plurality of magnetic erasable writable educational flash cards can form an educational flash card set. In addition, user can also use the same magnetic element die to make as many identical educational flash cards as needed in a learning game or activity. The magnetic die is permanently attached on the magnetic die assembly. All the magnetic die assemblies are securely fastened and integrated into the magnetic writer to prevent individual magnetic die assembly from missing or a set of magnetic die assemblies from being randomly mixed up.

Another object of the present invention is to provide an educational flash card that the user especially young child can play with it by writing display content on a flash card—making the learning process enjoyable. Young children always like to participate and participation is one of the most effective ways to keep them engaged. When a child is presented with a magnetically erasable writable educational flash card of the present invention, the child can manipulate the card to discover that visual display appears and disappears on the card like magic. Such participation brings enjoyment and excitement into the learning process, which in turn improves learning effectiveness and efficiency.

Another object of the present invention is to provide a magnetically erasable writable educational flash card that has certain mass, size and stiffness. Certain mass, size and stiffness makes the card feel like a toy that is ergonomically fitful for young children to play and manipulate with. The beginning of learning age of young children is also the time period when they develop their fine motor skills. Cards of certain mass, size and stiffness will require certain endeavor for young children to manipulate them around. The method to use a magnetic writer to create the visual display onto the flash card requires efforts to apply small movement to the card—an exercise to develop coordination between the child's hands and eyes. Such movement will be beneficial to a child's fine motor skills development.

Another object of the present invention is to provide a magnetically erasable writable educational flash card set that children can play as a learning toy and parents can use as a structured educational and teaching tool. It is envisioned that multiple participants can use the magnetically erasable writable educational flash cards to play games designed for a learning subject or entertainment of choice, for example, the scrambling and unscrambling word game in language learning, the game of Tic-Tac-Toe that comprises symbols of x and o for fun, or the like.

### BRIEF DESCRIPTION OF THE SEVERAL VIEWS OF THE DRAWING

Exemplary embodiments of the present invention will now be described. The present invention will become apparent upon reference to these accompanying drawings.

FIG. 1 is a perspective view of exemplary embodiments of the present invention.

FIG. 2 provides a perspective view of a magnetically erasable writable educational flash card representing the second exemplary embodiment of the present invention.

FIG. 3 is a perspective view of an exemplary magnetically erasable writable educational flash card set.

FIG. 4A is a perspective view of a magnetic die assembly.

FIG. 4B is an exploded perspective view of a magnetic die assembly.

FIG. 5A is a perspective view of one side of a magnetic die assembly.

FIG. 5B is a perspective view that shows magnetic dies on both sides of a magnetic die assembly that has more than one magnetic die.

FIG. 5C is a side view of a magnetic die assembly.

FIG. 6A is a perspective view of a magnetic writer.

FIG. 6B is an exploded perspective view of a magnetic writer.

FIG. 7A is a perspective view of a magnetically erasable writable educational flash card and a magnetic writer in writing process to create an educational flash card.

FIG. 7B is an enlarged perspective view of a selected portion of FIG. 7A illustrating a method to write visual display of a predetermined pattern on a magnetically erasable writable educational flash card.

### DETAILED DESCRIPTION OF THE INVENTION

A magnetically erasable writable educational flash card of the present invention is now described in detail with reference to the exemplary embodiments diagrammed in the drawings.

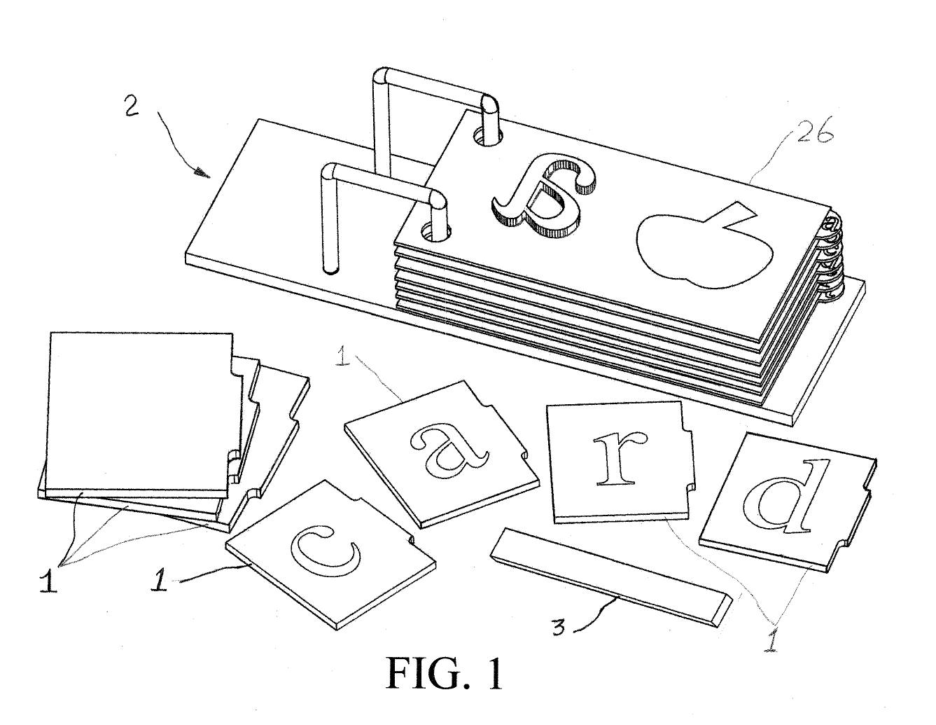

FIG. 1 is a perspective view of exemplary embodiments of the present invention. They include at least one regular sized magnetically erasable writable educational flash card 1 comprising magnetic display panel, a magnetic writer 2 comprising at least one magnetic die assembly 26, and at least one magnetic eraser 3. It should be readily understood that FIG. 1 shows limited number of magnetically erasable writable educational flash cards 1 and magnetic die assemblies 26—to be specific, a group of three blank flash cards 1, four flash cards 1 visually displaying lower case English alphabet “c”, “a”, “r”, and “d” respectively, and seven magnetic die assemblies 26 in the magnetic writer 2. Such limited number of components is only for exemplary purpose. The apparatus may comprise indefinite number of magnetically erasable writable educational flash cards 1 and magnetic die assemblies 26 depending on the specific learning subject.

The magnetic eraser 3 is a magnetic erasure element representing the first embodiment of the present invention. The magnetic eraser 3 is used to provide a magnetic field at the opposite side of the displaying side to pull the magnetic particles in the magnetic display panel away from the displaying side where these magnetic particles have created a visual display, thereby erasing completely the visual display on the magnetically erasable writable educational flash card 1, which will be described subsequently in detail. By moving and sliding the magnetic eraser 3 on the opposite side of the displaying side, the visual display on flash card 1 can be erased. The magnetic eraser 3 can be made with a cutout from any type of commercially available permanently magnetized magnetic strip, tape or sheet that has enough magnetic pull or strength to pull away the magnetic particles in the magnetic display panel from its displaying side. The magnetic eraser 3 can be made as a stand-alone piece, as illustrated in FIG. 1. The magnetic eraser 3 can also optionally be attached to the magnetic writer 2 or the flash card 1. A stand-alone magnetic eraser 3 provides cost benefit while an attached eraser 3 provides convenience.

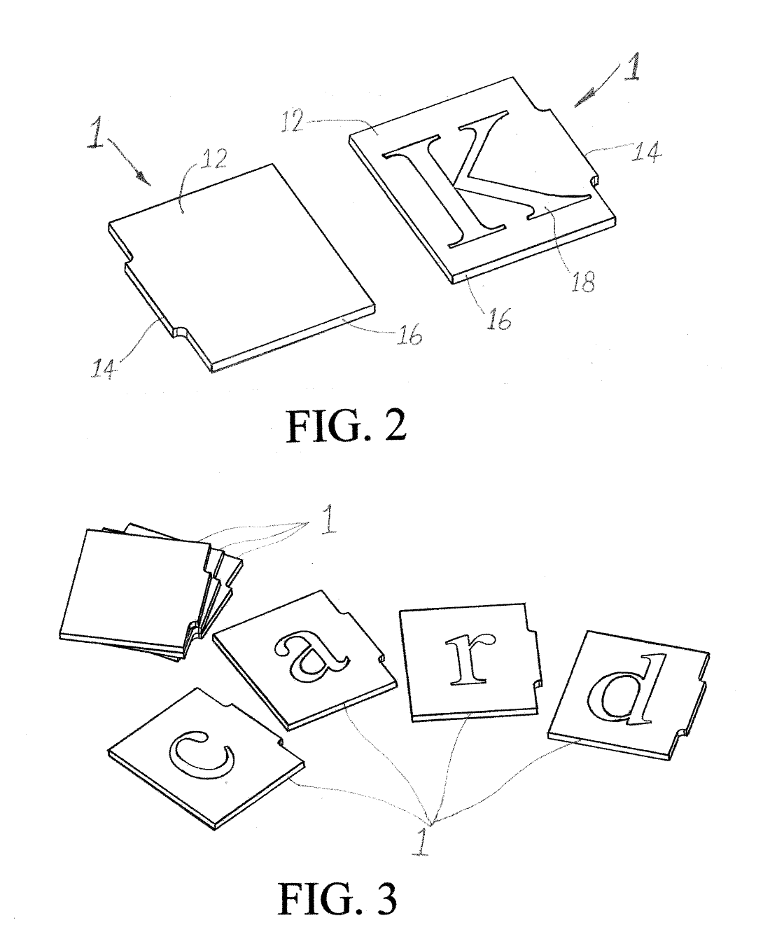

FIG. 2 provides a perspective view of a magnetically erasable writable educational flash card 1 representing the second exemplary embodiment of the present invention. Two magnetically erasable writable educational flash cards 1 are placed side by side with one of these two cards in a state without visual display but ready for being written and the other in a state with visual display 18 after having been written. As shown in FIG. 2, a magnetically erasable writable educational flash card 1 comprises a magnetic display panel 12 with shape and size of a traditional flash card onto which visual display 18 can be written, optionally a housing 16 to mount and support the magnetic display panel 12 for added stiffness if necessary, and optionally along one side of the card a motion limiter 14. Typical size of viewing area of the magnetic display panel 12 can be the size of a credit card, or approximately 85 mm×54 mm. It should be readily understood that a definite size is neither critical nor necessary as long as the size is ergonomically fit for young children to manipulate. There are various types of commercially available magnetic display panel to choose from to make a desirable size of magnetic display panel 12. Some types of magnetic display panel 12 have enough stiffness therefore a housing 16 is not necessary. Other types of magnetic display panel 12 are soft and flexible like a traditional paper therefore a housing 16 is necessary. In such condition, a housing 16 provides stiffness and mechanical support to the magnetic display panel 12 so that the magnetic display panel 12 keeps a planar shape without bend or warping during a small sliding movement in contact with the magnetic die assembly 26 to ensure an effective and uniform visual display creation. The housing 16 should be made with non-magnetic materials such as plastic, wood, non-magnetic stainless steel, or the like and combinations thereof. The housing 16 is either hidden from view of the magnetic display panel 12 or constructed in such a way that the viewable size of housing 16 is substantially insignificant comparing to the view area of the magnetic display panel 12, serving as a decorative frame.

A motion limiter 14 in FIG. 2 is a small extrusion of a middle portion of one edge of the magnetically erasable writable educational flash card 1. During the writing process, the motion limiter 14 functions together with the magnetic writer 2 to limit amplitude of the repeated small contact sliding movement. The length of the motion limiter 14 is critical to the amplitude of the contact sliding movement. In general, for an extrusion type of motion limiter 14, the longer the motion limiter 14, the smaller the amplitude of the small contact sliding movement. It should be readily understood that the motion limiter 14 can be an intrusion type where smaller intrusion(s) at one edge of the flash card 1 is made, or the like and combinations thereof. The motion limiter 14 is optional if other motion limiting means are built in the magnetic writer 2.

FIG. 3 is a perspective view of an exemplary set of magnetically erasable writable educational flash cards 1. This set comprises seven cards, of which three are blank and four visually display lower case English alphabet “c”, “a”, “r”, and “d” respectively forming the English word “card”. Because they are magnetically erasable writable educational flash cards, their displays can be erased and written with any predetermined pattern such as text characters of a language, Arabic numerals, symbols or graphical pictures of a desired learning subject or combinations thereof. For example, these seven cards can be written with “E”, “n”, “g”, “l”, “i”, “s”, and “h” to form the word “English”. The very same cards can again be written with “6”, “×”, “=”, and “3” to form arithmetic expression 6×6=36. As such, it is readily understood that an indefinite number of magnetically erasable writable educational flash cards 1 can comprise an educational flash card set for any learning subject.

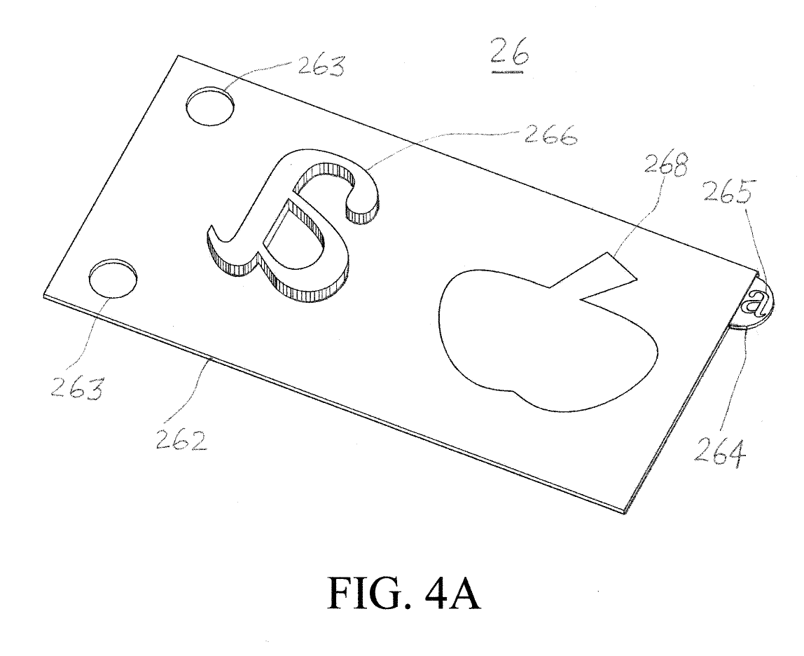

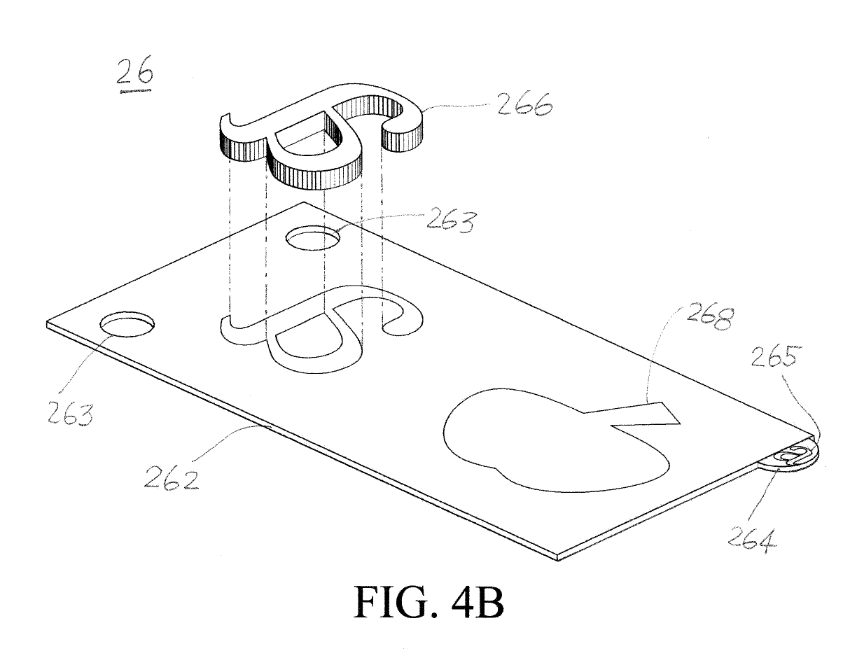

FIG. 4A is a perspective view of a magnetic die assembly 26 representing the third exemplary embodiment of the present invention. A magnetic die assembly 26 comprises a base 262, two through-the-base holes 263, an index tab 264, an index label 265, at least one magnetic die 266 and optionally visual indicia 268 that is informationally related to the magnetic die 266. The base 262 can be constructed with a rigid planar board of rectangular shape or other shape of desire. The planar board should be made with non-magnetic materials of certain stiffness to prevent the board from bending or warping upon a young child's manipulation. There are two through-the-base holes 263 close to one edge of the base 262. These holes are located apart toward the corners of the base 262 and an imaginary straight line through their centers should be parallel to the edge that the holes are close to. These holes provide means to integrate the magnetic die assembly 26 into the magnetic writer 2, which will be discussed in detail subsequently. There is an index tab 264 on one edge of base 262 that is opposite to the edge where through-the-base holes 263 are close to. A visual index label 265 is printed or attached with adhesive onto the index tab 264. The index label 265 provides means to index a plurality of magnetic die assemblies 26 in the magnetic writer 2 in such a way that it is fast and efficient to select a particular magnetic die assembly 26 when needed. For example, a set of ten magnetic die assemblies 26 each with one distinct Arabic numeral magnetic die 266 can have their indices labeled from “0” to “9” respectively corresponding to the magnetic die 266 on that die assembly 26 and the set is indexed according to an ascending order in the magnetic writer 2. Such ascending order makes it fast and efficient to locate any magnetic die assembly of a specific Arabic numeral. The magnetic die 266 is made of magnetic materials with predetermined pattern such as text character of a language, Arabic numeral, symbol or graphical picture of a learning subject and combinations thereof. The magnetic die 266 is in planar form and has certain thickness so that its planar face rises above the planar surface of the base 262 to ensure effective contact with the magnetic display panel 12 during a writing process. Preferably the magnetic die has a thickness of 0.64 mm or higher in consideration of current commercially available low cost magnetic materials. Other preferred thickness is possible within the scope of the present invention. The magnetic die 266 can be cut into shape from magnetic sheet materials or can be molded into the die pattern by permanently magnetized molding compound or can be printed with magnetic ink or the like. It is preferred that the magnetic materials used for the die is multi-pole magnetized. It is readily understood that variations of shape and materials to make the dies by a person skilled in the art are possible within the scope of the invention. The visual indicia 268 is printed or attached on the base 262. The visual indicia 268 presents the learning subject that is informationally related to the magnetic die 266. For example, image of an apple printed on the base 262 is informationally related to the magnetic die 266 of English letter “a” because “apple” starts with “a”. Also, the visual indicia can just be a typical print of conventional paper flash card with an “a” and image includes an apple.

FIG. 4B is an exploded perspective view depicting the construction of the magnetic die assembly 26 with a magnetic die 266 and a base 262. The magnetic die 266 is permanently secured onto the base 262 in such a way that the mirrored silhouette of the magnetic die 266 onto the magnetic display panel 12 delivers desired regular visual pattern display 18. To this end, the magnetic die 266 of predetermined pattern must be reversely assembled onto the base 262 to form a magnetic die assembly 26 in a way similar to having indicia embossed on a stamping die.

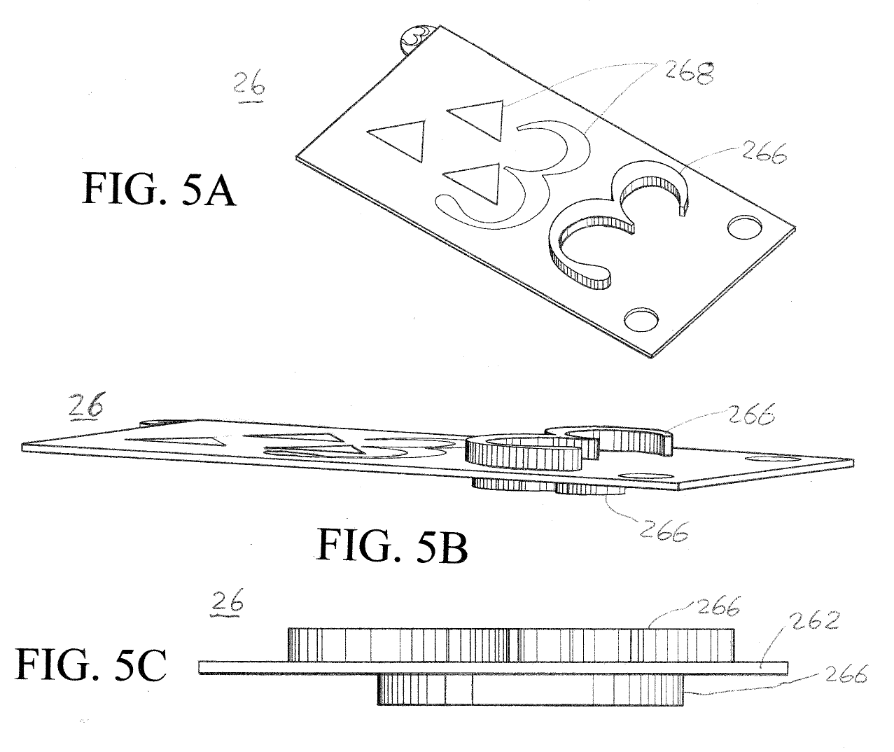

FIGS. 5A-5C illustrate various views of a magnetic die assembly 26 having dies and their related indicia on both surfaces of the base 262. FIG. 5A is a perspective view of one side of the magnetic die assembly 26, FIG. 5B is a perspective view that shows magnetic dies on both sides of a magnetic die assembly 26, and FIG. 5C is a side view of a magnetic die assembly 26 depicting that magnetic dies 266 have certain thickness and their magnetized planar faces rise above the planar surfaces of the base 262 to ensure their effective contact with the magnetic display panel 12. It should be readily understood that such thickness may not be significant if the magnetic dies 266 are printed on the surfaces of the base 262 by an adopted printing process.

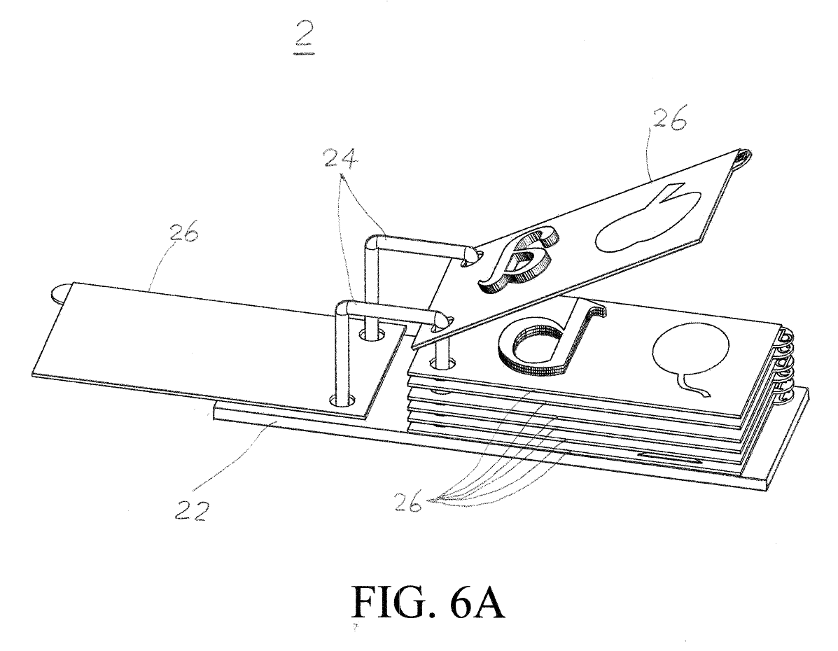

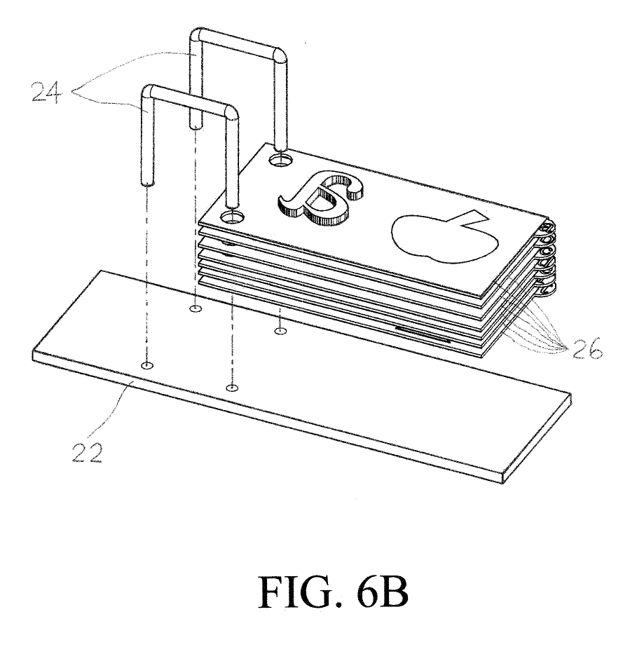

FIG. 6A is a perspective view of a magnetic writer 2 representing the fourth exemplary embodiment of the present invention. The magnetic writer provides a plurality of magnetic die assemblies with each magnetic die being an element of a particular learning subject and a complete set of magnetic dies presenting a complete set of elements of the learning subject. For example, each magnetic English alphabet letter die is an element of the learning subject of English language and a set of twenty six letter dies present a complete set of elements of the learning subject of English language. The magnetic writer 2 comprises a supporting housing 22, two integrators 24 and at least one magnetic die assembly 26. The magnetic writer 2 provides means to integrate magnetic die assemblies 26 in an orderly manner. In addition, the magnetic writer 2 provides means to control the amplitude of a repeated small sliding movement of the surface of a magnetic display panel 12 in contact with the face of the magnetic die 266. Such small amplitude contact sliding movement is necessary to create an improved, high resolution and high contrast visual mirror silhouette of the pattern of the magnetic die 266 on the magnetic display panel 12. The supporting housing 22 is of rectangular shape and is made with non-magnetic board materials such as plastic, wood, leather, non-magnetic stainless steel, or the like and combinations thereof. The supporting housing 22 provides protection to the magnetic die assemblies 26 and a solid mounting support for the integrators 24. Two integrators 24 are used to integrate the magnetic die assemblies 26 into the magnetic writer 2 through their integration holes 263 in an indexed orderly manner. The integrators 24 are rigidly fastened onto the supporting housing 22 such that they do not become loose after being repeatedly subject to small pushing forces from side during normal writing activities. The integrators 24 can be detached off and attached back onto the supporting housing 22 for the purpose of adding magnetic die assemblies 26 to or taking them off from the magnetic writer 2. The fastening mechanism of the integrators 24 onto the base 22 is preferred to be childproof so that only intended change of the magnetic die assembly 26 is allowed, preventing the magnetic die assemblies 26 from missing or randomly mixing up as a result of children's playing with these magnetic assemblies. Such mixing and missing that leads to frustration and inefficiency are common when children play the conventional paper flash cards. The integrators 24 can be made with plastic or non-magnetic metals molded into the desired upside down “U” shape. After integration, the magnetic writer 2 functions similar to a binder book in which a magnetic die assembly 26 can be turned back and forth like a page. In this figure FIG. 6A, the magnetic die assembly with a magnetic die of letter “a” is shown in its turning process with other magnetic die assemblies sitting on both sides. By turning magnetic die assembly back and forth, user can quickly find a specific magnetic die assembly 26 to use by following the orderly indices.

FIG. 6B is an exploded perspective view depicting the construction of the magnetic writer 2. A set of magnetic die assemblies 26 are integrated into the magnetic writer 2 by fastening the integrators 24 onto the supporting housing 22 through their integration holes 263.

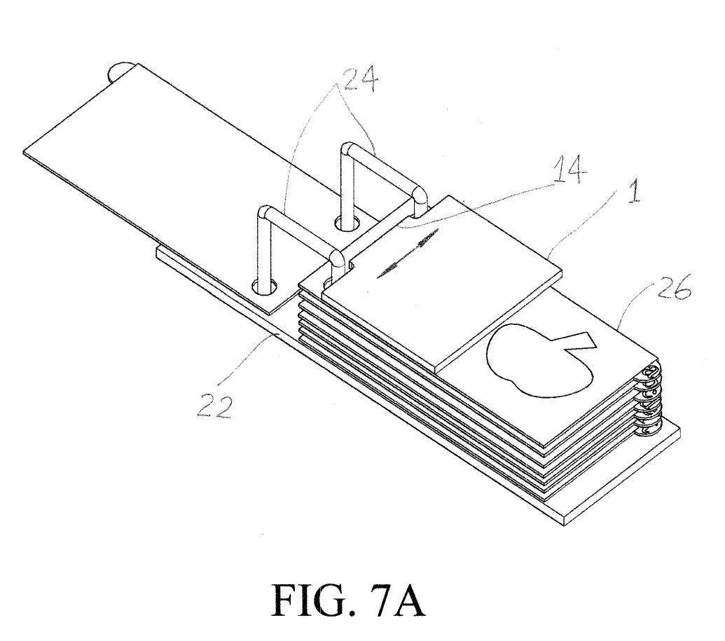

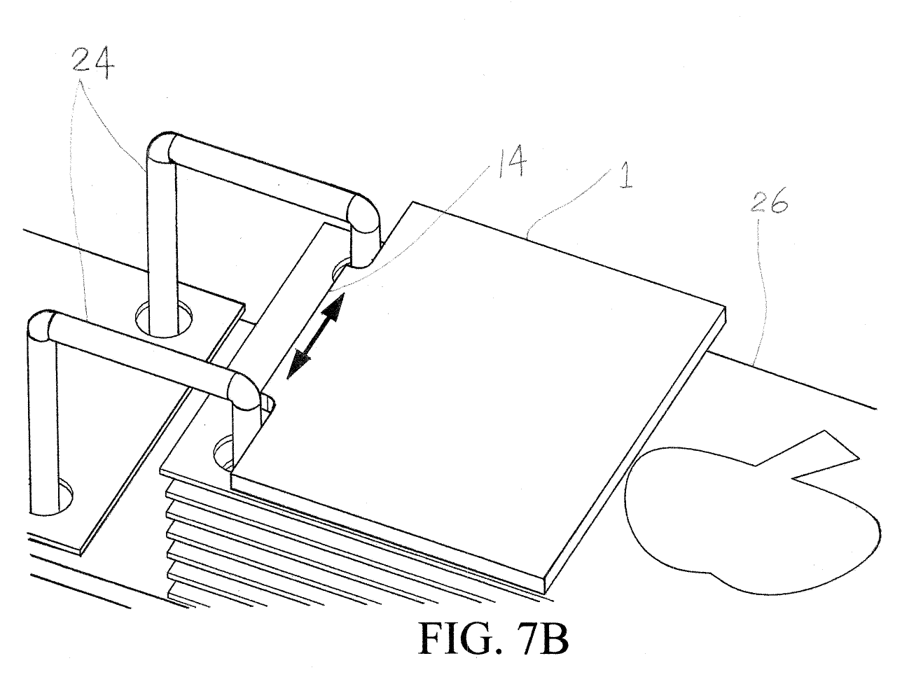

FIG. 7A is a perspective view of a magnetically erasable writable educational flash card 1 and a magnetic writer 2 in writing process to create a visual display on the flash card 1, representing the fifth exemplary embodiment and a method of the present invention. A magnetically erasable writable educational flash card 1 is put onto a magnetic die assembly 26 of the magnetic writer 2 with the magnetic display panel 12 of the flash card 1 in contact with the face of the magnetic die 266 of the magnetic die assembly 26. The edge of the flash card 1 that the motion limiter 14 is attached to is slid against integrators 24 with the motion limiter 14 placed in between the integrators 24. User then applies on the flash card 1 a repeated small amplitude contact sliding movement in a direction shown by the arrows that is parallel to the plane that contains the contact surface. Such action provides a repeated small amplitude contact sliding movement, or rubbing, of the magnetic die 266 on the magnetic display panel 12 to create visual display of a mirrored silhouette of the magnetic die 266 of predetermined pattern on the magnetic display panel 12. To be more specific, FIG. 7B is an enlarged perspective view of a selected portion of FIG. 7A illustrating the movement amplitude control of the above described visual display creation method. The motion limiter 14 is placed in between the integrators 24. The spare room between the motion limiter 14 and the integrators 24 controls the movement amplitude of the flash card 1. It can be readily understood that the longer the motion limiter 14 the smaller the spare room between the motion limiter 14 and the integrators 24. In other words, smaller movement amplitude of the flash card 1 is achieved. Small amplitude movement is necessary to create an improved, high resolution and high contrast visual display of a mirrored silhouette of the magnetic die after carefully conducted research and design experiment. An experiment report is cited here to clearly demonstrate the improvement of quality of the visual display. Young children can find lots of fun manipulating the card, making letters, pictures, symbols, or the like and combinations thereof and never feel bored. Such manipulation can help to develop young children's fine motor skills.

The present invention has mainly been described above with reference to certain explicitly disclosed exemplary embodiments thereof. However, as is readily appreciated by any person skilled in the art, other embodiments than the ones disclosed above are equally possible within the scope of the invention, as defined by the appended patent claims. It should be understood that all terms used in the claims are to be interpreted according to their ordinary meaning in the technical field, unless explicitly defined otherwise herein.

What is claimed is:

1. A magnetically erasable writable educational flash card comprising:
magnetic display panel visually displaying predetermined pattern.

2. The magnetically erasable writable educational flash card of claim 1, wherein said predetermined pattern comprises text character of a language, Arabic number, or graphical picture of a learning subject and combinations thereof.

3. A magnetically erasable writable educational flash card according to claim 1, further including means for providing additional stiffness to said magnetic display panel.

4. A magnetically erasable writable educational flash card according to claim 1, further including means for providing movement limitation in a writing process.

5. An educational flash card set, comprising:
a plurality of magnetically erasable writable educational flash cards.

6. The educational flash card set of claim 5, wherein each flash card comprises an element of a learning subject and an adequate number of the flash cards comprise a complete set of elements of the learning subject.

7. A magnetic writer comprising:
at least one magnetic die assembly,
a supporting housing, and
integration means for integrating at least one said magnetic die assembly and said supporting housing,
whereby at least one said magnetic die assembly and said supporting housing are integrated into a complete assemblage.

8. The magnetic writer according to claim 7, wherein said magnetic die assembly comprises a base, at least one magnetic die of predetermined pattern, an assembly identification, and optional visual informational indicia, whereby said magnetic die, said assembly identification, and said optional visual informational indicia are permanently secured to said base, forming the magnetic die assembly.

9. The magnetic writer according to claim 8, wherein said base is a rigid planar board of two opposing major surfaces.

10. The magnetic writer according to claim 8, wherein said magnetic die of predetermined pattern comprises pattern such as text character of a language, Arabic number, or graphical picture of a learning subject and combinations thereof.

11. The magnetic writer according to claim 8, wherein said assembly identification comprises means that are visually specific and unique to a magnetic die assembly for efficient selection of the magnetic die assembly among a plurality of magnetic die assemblies.

12. The magnetic writer according to claim 8, wherein said visual informational indicia is related to said magnetic die.

13. The magnetic writer according to claim 7, wherein said magnetic die assembly further comprises means for securely integrating the magnetic die assembly into said magnetic writer.

14. The magnetic writer according to claim 7, wherein said supporting housing is made with board materials such as plastic, wood, leather, stainless steel, or the like and combinations thereof.

15. The magnetic writer according to claim 7, wherein said integration means comprise two integrators that are securely fastened onto the supporting housing.

16. A method for creating visual display of a mirrored silhouette of a magnetic die of predetermined pattern on a magnetic display panel, comprising the steps of:
a. aligning the display surface of said magnetic display panel in contact with the face of said magnetic die of predetermined pattern, and
b. applying repeated small amplitude contact sliding movement to said magnetic display panel,
whereby visual display of a mirrored silhouette of said magnetic die of predetermined pattern will be created on said magnetic display panel.
